(19) United States
(12) Patent Application Publication
(10) Pub. No.: US 2017/0057593 A1
(43) Pub. Date: Mar. 2, 2017

(54) COUPLING

(71) Applicant: Croozer GmbH, Koln (DE)

(72) Inventors: Roger GRAY, London (GB); Georg SCHNEIDER, Meckenheim (DE)

(21) Appl. No.: 15/243,083

(22) Filed: Aug. 22, 2016

(30) Foreign Application Priority Data
Aug. 24, 2015 (DE) 102015114022.5

(51) Int. Cl. B62K 27/12; F16B 7/04

(52) U.S. Cl. CPC B62K 27/12; F16B 7/044

(57) ABSTRACT

The invention relates to a coupling for connecting and/or holding together two parts, in particular for a bicycle trailer, having a first and a second coupling part which cooperate and can be released from each other, one of which is an insert piece which is connected to one of the parts and the other is a sleeve which is connected to the other part, the sleeve being capable of at least partly engaging around the insert piece, and the first coupling part having at least one locking groove (22, 103). To achieve a constructively simple coupling with a simple handling ability, mounted on or in the second coupling part is at least one locking shaft (4, 96) which has at least one locking segment having in the peripheral direction at least one locking portion (31, 131) and one unlocking portion (32, 132), the locking portion (31, 131) having a greater radial extent than the unlocking portion (32, 132). The locking shaft (4, 96) is arranged so that the locking portion (31, 131) can engage in the locking groove (22, 103) when the insert piece has been introduced into the sleeve, and the unlocking portion (32, 132) cannot engage in the locking groove (22, 103). Furthermore, means are provided for rotating the locking portion (31, 131) into the locking position, for holding the locking portion (31, 131) in the locking position and for releasing the locking portion (31, 131) from the locking position.

The present invention relates to a coupling for connecting and/or holding two parts together, in particular for a bicycle trailer, having a first and a second coupling part which cooperate and can be released from one another, one of which is an insert piece which is connected to one of the parts and the other is a sleeve which is connected to the other part, the sleeve being capable of at least partly engaging around the insert piece, and the first coupling part having at least one locking groove.

Bicycle trailers are becoming increasingly popular. This is due to the fact, inter alia, that the possibilities of use of bicycle trailers are being constantly expanded. Thus, there are multifunctional children's bicycle trailers which, apart from the trailer operation by a simple modification, also afford the possibility of using the bicycle trailer as a pushchair or as a so-called jogger. For this purpose, a front wheel is attached to the chassis of the bicycle trailer and the drawbar of the trailer is removed or folded away for the respective function. Thus, various parts have to be connected to, or removed from the bicycle trailer. Furthermore, for operation as a bicycle trailer, the trailer has to be routinely coupled to a bicycle or to a pedelec or uncoupled therefrom.

To improve the handling ability when coupling the drawbar to and uncoupling it from a bicycle, WO 2013/15678 discloses a trailer coupling with two coupling parts which cooperate and can be released from one another, one of which is connected in a stationary manner to the vehicle and the other is connected to the drawbar. One of the coupling parts is a coupling bolt with a peripheral groove and the other is a bushing which encompasses the coupling bolt. A locking pin can be introduced into a guide in the bushing and secured therein such that the locking pin engages in the peripheral locking groove in the coupling bolt inserted into the bushing and thus safeguards the coupling bolt against slipping axially out of the bushing. It is also known from WO 2013/15678, instead of using a locking pin, to provide spring clips which engage in the locking groove in the coupling bolt after the bushing has been placed on the coupling bolt. To release the bushing from the coupling bolt, the spring clips can be pressed out of the locking groove by a pushbutton as an unlocking means so that the coupling bolt is free again and can be removed from the bushing.

Finally, WO 2013/15678 also discloses a lock for locking the unlocking means or as theft protection.

On this basis, an object of the present invention is to provide a constructively simple coupling with a simple handling ability.

This object is achieved with a coupling of the type mentioned at the outset having the features of Claim 1, in that mounted on or in the second coupling part is at least one locking shaft which has at least one locking segment having in the peripheral direction at least one locking portion and one unlocking portion, the locking portion having a greater radial extent than the unlocking portion, the locking shaft being arranged so that the locking portion can engage in the locking groove when the insert piece has been introduced into the sleeve and the unlocking portion cannot engage in the locking groove, means being provided for rotating the locking portion into the locking position, for holding the locking portion in the locking position and for releasing the locking portion from the locking position.

An essential core aspect of the present invention lies in the locking shaft which is mounted in the second coupling part and is configured and mounted such that the locking portion thereof can engage in the locking groove in the first coupling part and can thus lock the first coupling part and the second coupling part, and such that the locking shaft can free the locking groove and thereby the first coupling part again by a simple rotation in that the locking portion is rotated out of the locking groove. A locking shaft of this type allows an extremely compact and robust construction of the coupling.

In principle, it is of no consequence whether the locking groove is formed in the insert piece and the locking shaft is coupled to the sleeve or whether the locking groove is formed in the sleeve and the locking shaft is provided on the insert piece, the latter configuration being possible in terms of construction, but being significantly more expensive.

Since the locking shaft merely has to be rotated in order to lock the insert piece in the sleeve, an essential advantage of the invention is that the forces required for connecting the coupling parts are relatively very low, yet a secure connection is ensured.

The coupling according to the invention can be used for a plurality of connections. Thus, the coupling according to the invention can simultaneously assume the function of a joint, particularly when the insert piece has a round cross section and is mounted rotatably in the sleeve. For example, the coupling according to the invention can be used as a trailer coupling for bicycle trailers to fasten the drawbar of a bicycle trailer to a bicycle, one of the two coupling parts being configured in a fixed manner with the bicycle and the other of the two coupling parts being configured at one end of the drawbar. The coupling can also be used to connect a suspension for a buggy wheel to the frame of a bicycle trailer, in which case the suspension of the buggy wheel is then mounted such that it can freely rotate about a substantially vertical axis.

However, it can also be advantageous if the coupling does not have any degree of freedom and in particular is not used as a joint. Thus, the insert piece can also have a non-circular cross section, for example an oval or a polygonal cross section which cooperates with a corresponding hollow cross section of the sleeve so that when the two coupling parts are locked, they cannot move relative to one another. Of course, means can also be provided which, in the locked state, block all possible degrees of freedom of the coupling parts. Such a coupling according to the invention is suitable, for example, for releasably connecting or fastening the drawbar on the bicycle trailer, the first coupling part being configured at one end of the drawbar and the second coupling part being configured on the frame of the bicycle trailer.

According to a preferred embodiment, the locking shaft has a rotational axis which is arranged substantially transversely to an insertion direction of the insert piece into the sleeve, preferably parallel to the locking groove. This has the essential advantage that during insertion, the locking portion of the locking shaft can be pushed to the side by the insert piece. The coupling according to the invention can be even more compact when the rotational axis of the locking shaft runs through a portion of the locking groove, the unlocking portion having a negative radial extent in respect of the rotational axis, thus that the rotational axis of the shaft runs through the recess. Thus, the rotational axis of the locking shaft does not have to be completely guided past the first coupling part, but can be positioned relatively closely to the first coupling part.

Of course, it is also possible to arrange the rotational axis of the locking shaft transversely to the locking groove so that the locking portion can be rotated into the locking groove lengthways to the locking groove. However, this is at the cost of the simple handling of the coupling.

In a further preferred embodiment of the coupling according to the invention, a spring which acts on the locking shaft, in particular a torsion spring is provided as a means for rotating the locking shaft into the locking position. Thus it is possible that when the insert piece is introduced into the sleeve, the locking portion of the locking shaft is deflected against a spring force by the insert piece and is then automatically rotated into the locking groove in the insert piece by the tensioned spring, as soon as the insert piece has been introduced far enough into the sleeve. This ensures an extremely simple coupling of the two coupling parts.

However, it is also possible to provide as a means for rotating the locking shaft into the locking position a crank or a lever for example, by which the locking shaft can be manually rotated.

It is preferably possible to provide as a means for holding the locking portion in the locking position a stop element on the locking shaft which cooperates with a stop element on the second coupling part. The stop element counteracts a rotating movement of the locking portion out of the locking groove, which is caused by a possible removal of the insert piece, so that when the first coupling part and the second coupling part are locked together, they can no longer be easily released from one another.

In this respect, it is advantageous if the locking shaft is held in the locking position by the stop element against a spring force so that the locking element is prevented from being able to move inside the locking groove, for example due to vibrations, or even from being inadvertently released therefrom. The spring used for this purpose can be the same spring which is used as the means for rotating the locking shaft into the locking position. In this case, it must be pretensioned accordingly.

Of course, other means can also be used for holding the locking portion, such as catch means or grippers which secure the locking shaft when it is in the locking position. It is also possible to provide holding means which hold a lever or a crank for manually rotating the locking shaft as soon as the shaft is in its locking position.

In a preferred embodiment according to the invention, as the means for releasing the locking shaft from its locking position, the locking shaft can have at least one unlocking segment with a stop surface which is provided on the outside of the locking shaft and which cooperates with a release mechanism for releasing the locking shaft from the locking position. The release mechanism can be, for example an automatic actuator, for example a lever which, when the insert piece is introduced into the sleeve, is tightened against a spring force and is locked when the locking shaft is in its locking position, and can be manually unlocked, the lever then acting on the stop surface and rotating the locking shaft out of its locking position into an unlocked position.

The stop surface of the unlocking segment, provided as a means for releasing the locking shaft from its locking position can be used at the same time as a stop element for holding the locking shaft in its locking position, namely when the release mechanism is firmly in a starting position such that in the locking position of the locking shaft, said locking shaft rests against the release mechanism by the stop surface. In this case, the release mechanism also has, in addition to the release function, a holding function as the stop element of the second coupling part.

The stop surface of the unlocking segment is preferably located in a plane which intersects the rotational axis of the locking shaft so that the forces applied by a release mechanism act on the shaft in the peripheral direction.

In a further preferred embodiment, the unlocking segment has a recess with a smaller radial extent than the outer radius of the locking portion, in a region located upstream of the stop surface in the actuation direction of the release mechanism. Consequently, the release mechanism can be guided closely past the core of the locking shaft, so that a relatively compact construction is possible.

A manual actuator is preferably provided as the means for releasing the locking portion from the locking position. Considered as manual actuators are, for example the aforementioned levers or cranks, using which the locking shaft can also be rotated manually into its locking position. The manual actuator preferably acts a release mechanism with the stop surface of the unlocking portion of the locking shaft. A particularly resiliently mounted pushbutton which acts on the locking shaft is preferably provided as the means for releasing the locking portion from its locking position, because it is very simple to operate. The particular advantage of the locking shaft of the coupling according to the invention is evident particularly in the embodiment with a pushbutton. Thus, it is possible to provide the direction of movement of the pushbutton in almost any direction, particularly in the insertion direction of the insert piece into the sleeve, but also transversely thereto, without a particular constructive expense being associated therewith. Thus, for example, it is easily possible to act on a corresponding stop on the locking shaft with a stop element configured on the pushbutton. If the actuation direction of the pushbutton runs parallel to the shaft, the effective surfaces of the stops can be formed obliquely so that, upon actuation of the pushbutton, the shaft-side stop is pushed to the side and the locking shaft is thereby rotated into the desired direction. If the actuation direction of the pushbutton is transverse to the rotational axis of the shaft, the cooperating stop surfaces on shaft and pushbutton preferably extend transversely to the actuation direction.

In a particularly preferred embodiment, the stop formed on the manual actuator is the stop element formed on the sleeve on the second coupling part, for holding the locking portion in the locking position. The stop formed on the manual actuator thereby has a double function, namely that of holding and releasing the locking portion from its locking position.

A pinion transmission is also considered as a further means for holding the locking shaft in and/or releasing the locking shaft from its locking position. For example, a manual actuator, such as a pushbutton or an automatic release mechanism, such as a motor with a toothed rack can be provided which cooperates either directly or indirectly via an intermediate pinion with a pinion arranged on the shaft.

In a further preferred embodiment of the invention, the coupling has a lock which is configured to be able to prevent an unauthorised release of the locking portion from the locking position. The lock can be configured, for example so that it can act on the locking shaft and can block it when it is closed. The lock is preferably configured such that it is able to block any actuation of the manual actuator.

If the coupling according to the invention is to have at least one degree of freedom, for example when used as a trailer coupling or as a coupling for connecting a buggy suspension to a front part of a bicycle trailer frame, the insert piece is preferably a coupling bolt with a substantially circular lateral surface in cross section and with at least one at least partly peripheral locking groove. As a result, the coupling can be configured so that the coupling bolt can be rotated about its longitudinal axis in the sleeve.

As already mentioned, the coupling according to the invention is particularly suitable as a trailer coupling for a bicycle trailer, and also for connecting the suspension of a buggy wheel to a front frame part of the bicycle trailer.

The coupling is also suitable for fastening the drawbar to the frame of a bicycle trailer when one of the two coupling parts is the end of the drawbar and the other coupling part is a drawbar mount formed on a bicycle trailer. In this embodiment, the bicycle trailer-side end of the drawbar is preferably configured with a locking groove as the first coupling element and the drawbar mount is configured as the second coupling element. For a coupling of this type, the first and second coupling parts preferably do not have any degrees of freedom in the locked state.

The coupling according to the invention makes it possible to connect a plurality of attachments of the bicycle trailer to a bicycle trailer simply by attaching or inserting one coupling part to or into the other coupling part and, if a respective pushbutton is provided, to release it from the bicycle trailer by actuating the pushbutton. The modification of the bicycle trailer thus becomes extremely simple, since each coupling follows a uniform, simple operating concept. Any incorrect handling by a user can be substantially avoided thereby.

Furthermore, the basic construction of the invention with a locking shaft which can lock the coupling by simply rotating into a locking groove in the insert piece or in the region of the sleeve, affords many constructive variants. If a manual actuator is used to release the coupling, it can optionally be arranged so that the actuation direction thereof extends in the longitudinal direction of the insert piece or transversely thereto.

If the coupling according to the invention is to have a lock and a pushbutton, and if the lock has a lock cylinder, the lock cylinder can optionally be arranged parallel to the actuation direction of the pushbutton. In a particular embodiment, the lock cylinder is mounted in the pushbutton. In a further alternative, the lock cylinder is mounted transversely to the actuation direction of the pushbutton.

In the following, the invention will be described in more detail with reference to figures which show preferred embodiments of the invention.

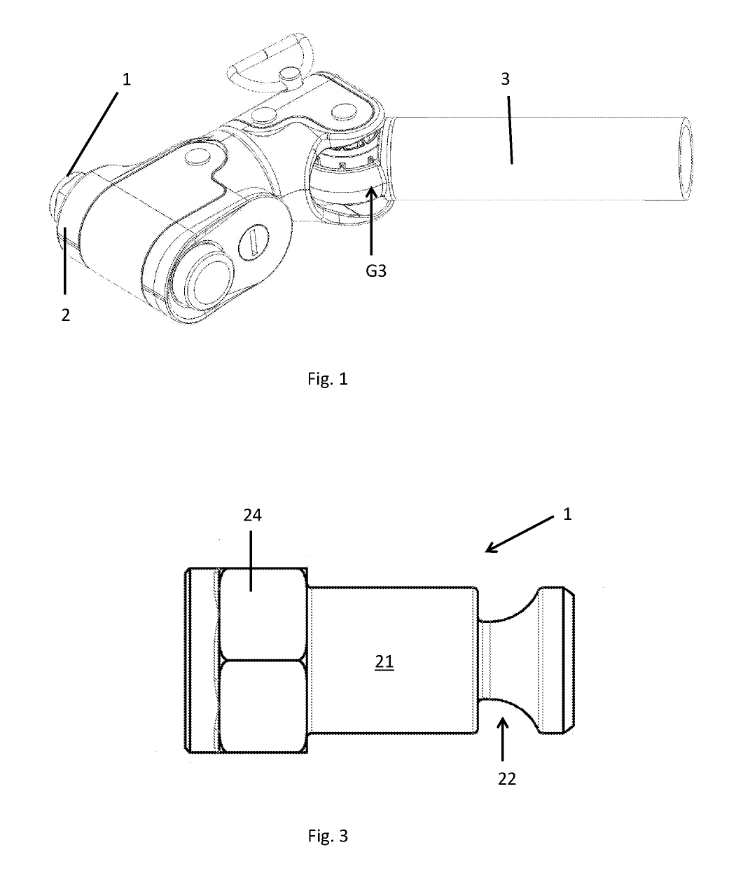

FIG. 1 is a perspective view of a coupling according to the invention as a trailer coupling;

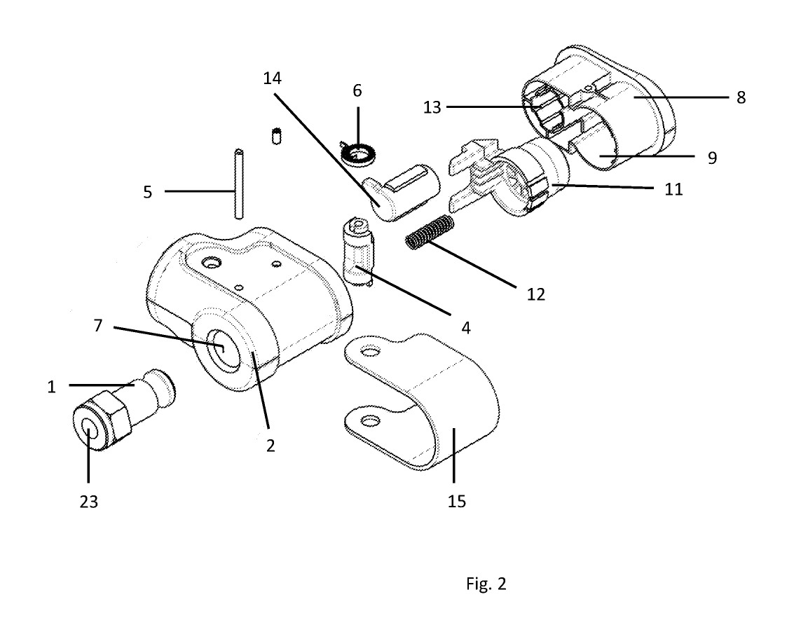

FIG. 2 is a view of individual components of the coupling shown in FIG. 1;

FIG. 3 is a side view of an insert piece of the coupling;

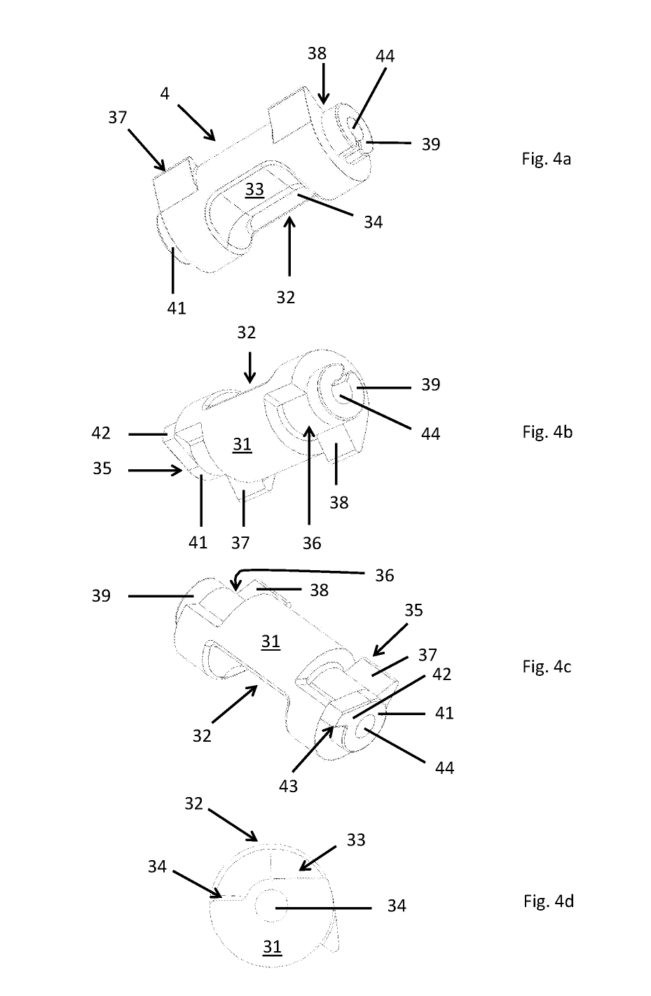

FIG. 4a to c are different perspective views of a locking shaft shown in FIG. 2;

FIG. 4d is a cross-sectional view of the locking shaft shown in FIG. 2;

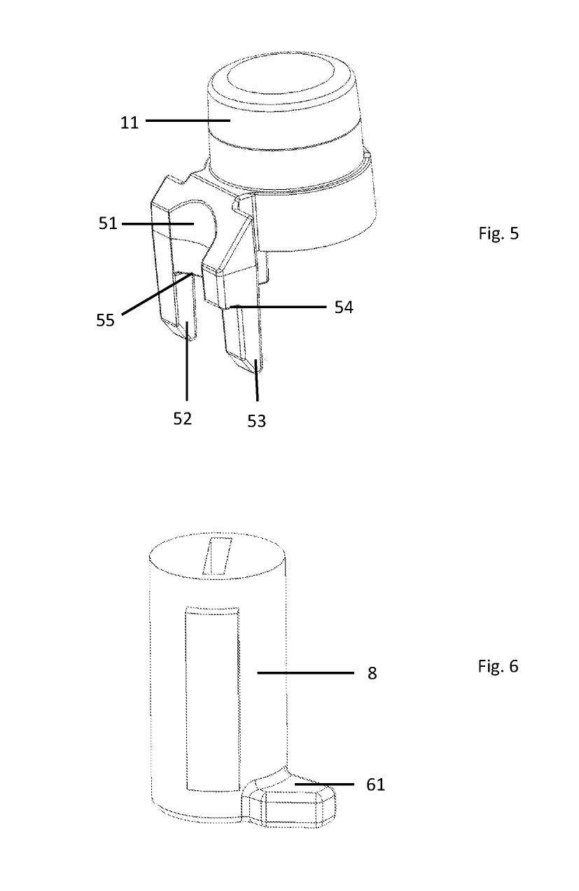

FIG. 5 is a perspective view of a pushbutton shown in FIG. 2;

FIG. 6 is a perspective view of a lock cylinder shown in FIG. 2;

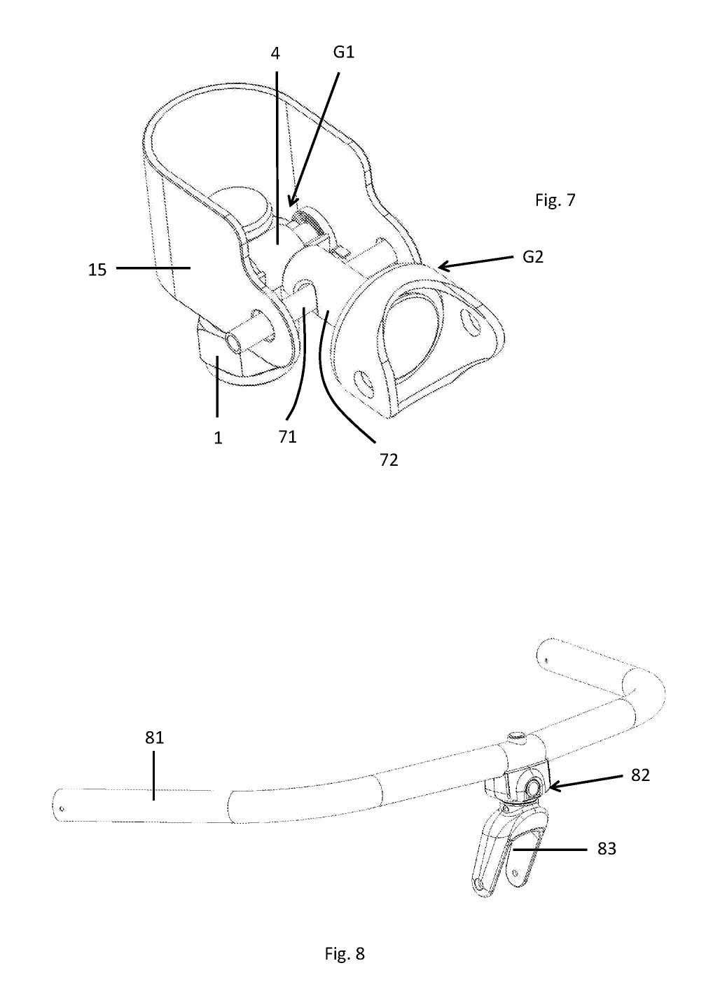

FIG. 7 is a view of some parts of the trailer coupling shown in FIGS. 1 and 2, to illustrate the degrees of freedom thereof;

FIG. 8 is a perspective view of a further coupling according to the invention for connecting a suspension for a buggy wheel to a frame of a bicycle trailer;

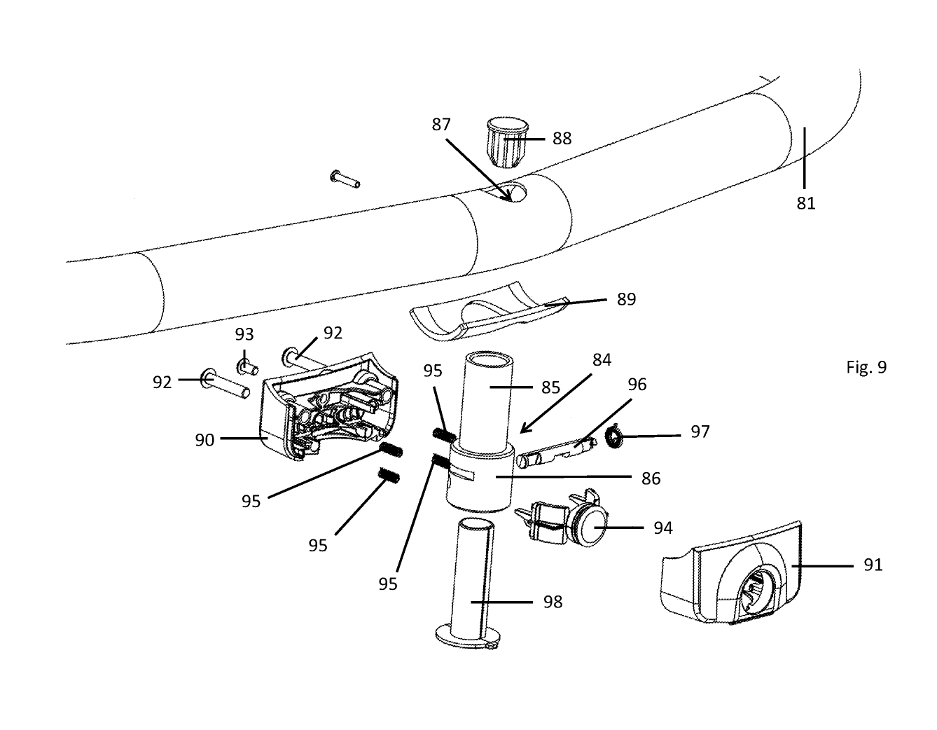

FIG. 9 is a view of individual components of the coupling shown in FIG. 8;

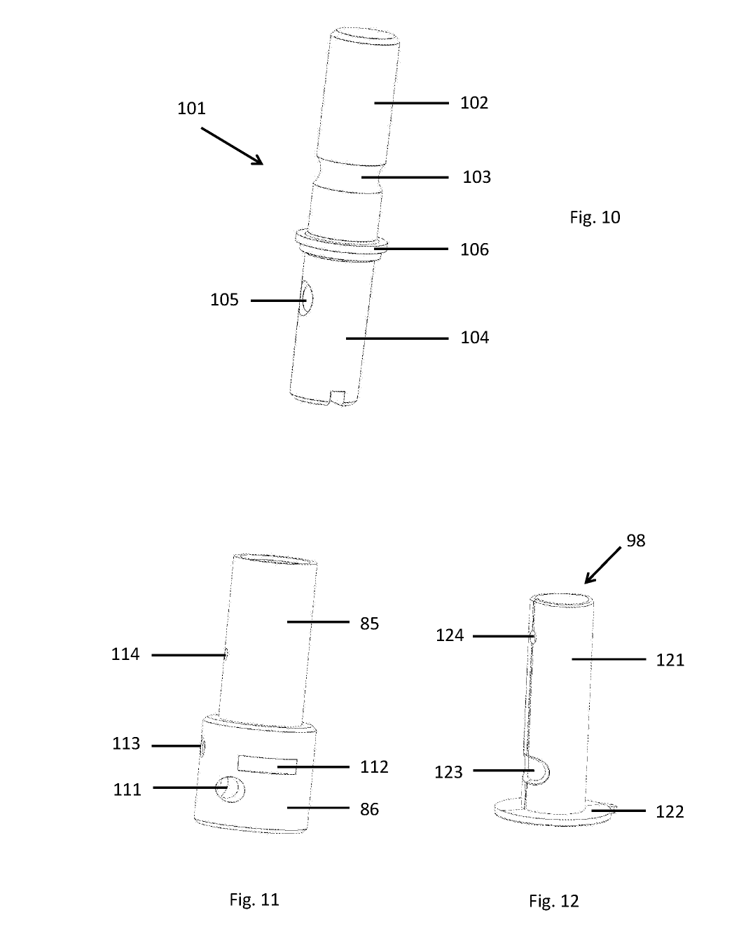

FIG. 10 is a view of a coupling bolt, shown in FIG. 9, as an insert piece;

FIG. 11 is a perspective view of a sleeve mount, shown in FIG. 9, of the coupling;

FIG. 12 is a perspective view of a sleeve shown in FIG. 9;

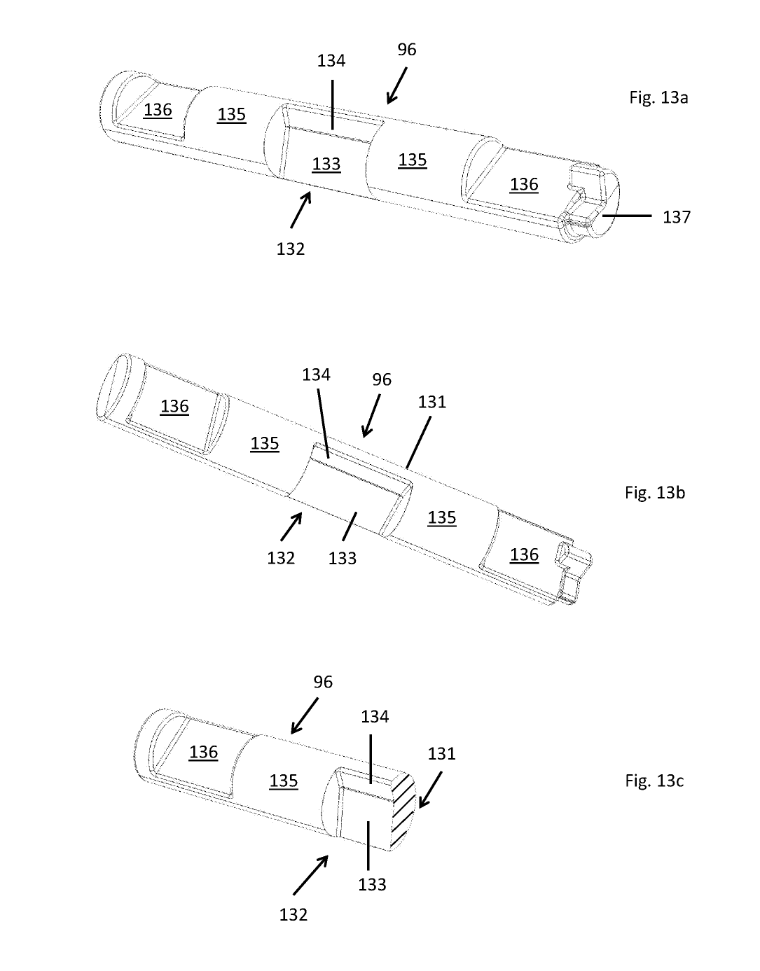

FIG. 13a, b are perspective views of a locking shaft shown in FIG. 9;

FIG. 13c is a sectional, perspective view of the locking shaft shown in FIGS. 13a and b;

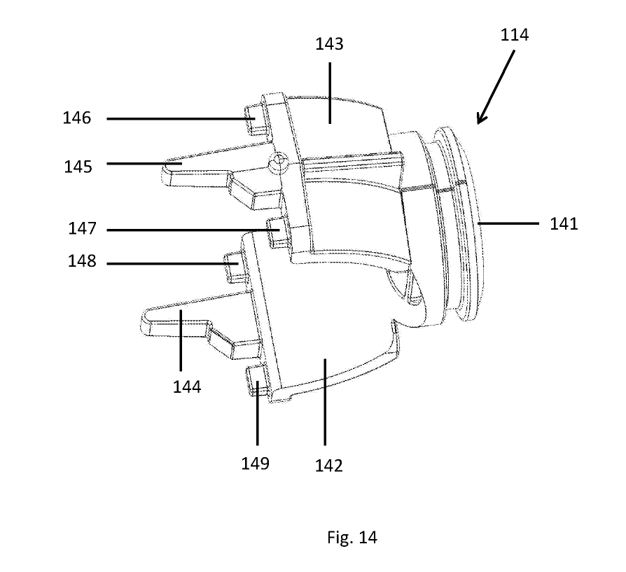

FIG. 14 is a view of a pushbutton shown in FIG. 9;

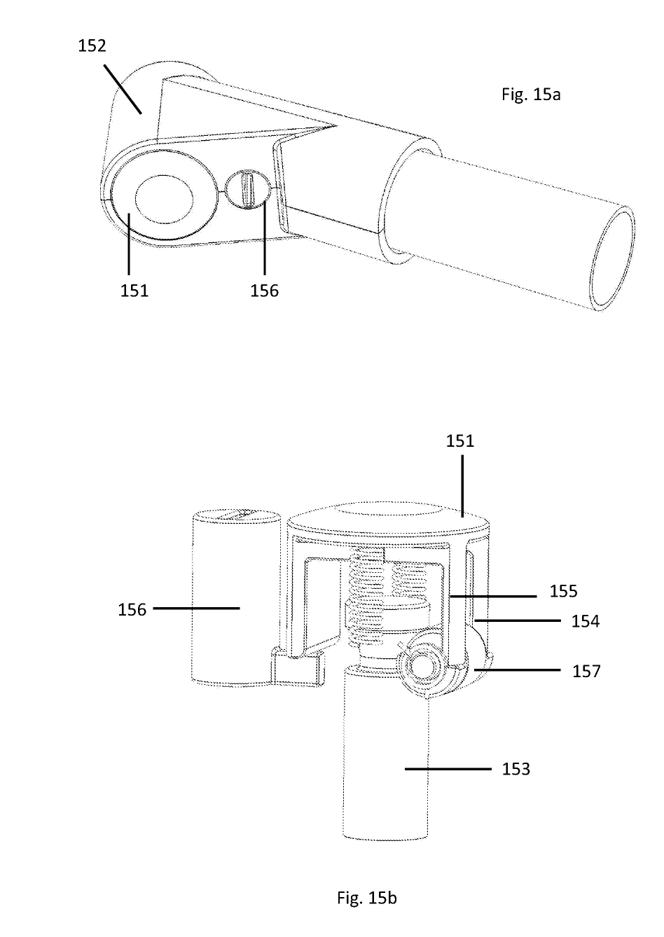

FIG. 15a, b show a principle of an arrangement of different components of a coupling according to the invention;

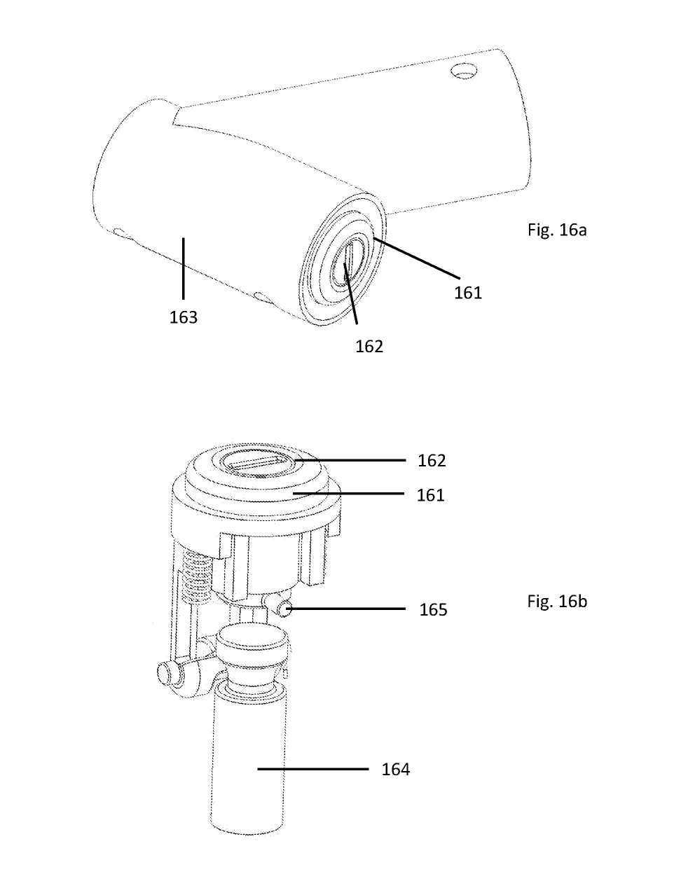

FIG. 16a, b show a further principle of an arrangement of different components of a coupling according to the invention; and

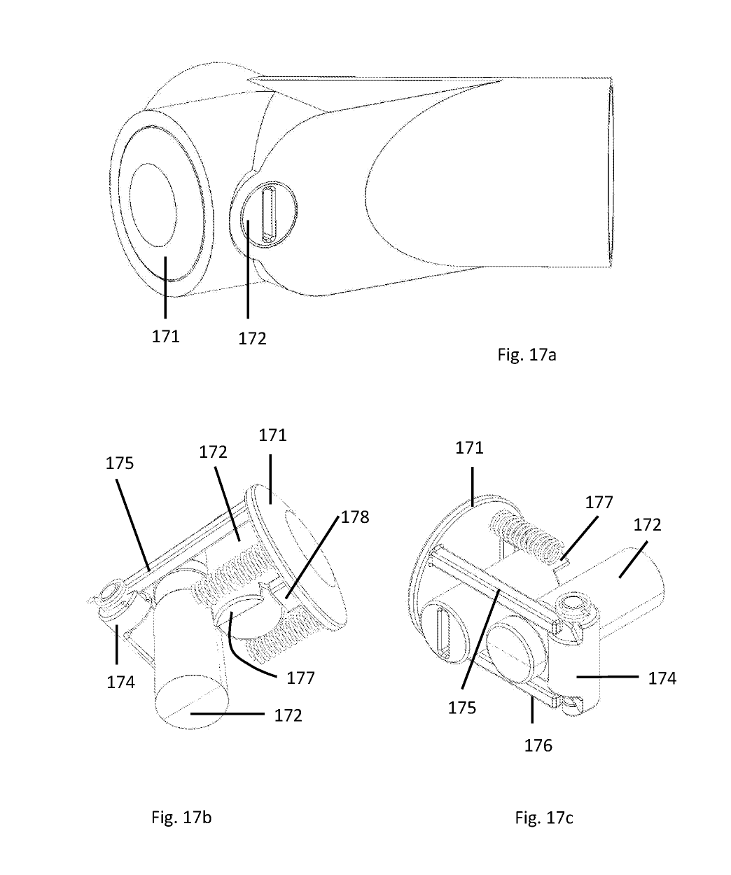

FIG. 17a to c show yet another principle of an arrangement of different components of a coupling according to the invention.

The trailer coupling according to the invention, shown in its entirety in FIG. 1 and with individual parts in FIG. 2, for a bicycle trailer has an insert piece, formed as a coupling bolt 1, and a sleeve (not shown) configured in a coupling housing 2. The coupling bolt 1 can be connected to a bicycle, for example in that it is screwed onto a thread at one end of a wheel axle of the bicycle. The coupling housing 2 is connected to a drawbar 3 by further elements of the coupling.

Positioned in the coupling housing 2 is a locking shaft 4 which is mounted on a spindle 5 and is subjected to a spring force by a torsion spring 6. While the coupling housing 2 has an opening 7 on one side for the coupling bolt 1 as access to the sleeve configured in the coupling housing 2, it is closed on the opposite side by a cover 8. Formed in the cover 8 is a mount 9 together with a guide for a pushbutton 11 which is movable in the cover in the direction of the sleeve against the force of a spring 12. Furthermore, the cover 8 has a mount 13 for a lock cylinder 14 which is arranged parallel to the pushbutton 11. The coupling housing 2 which, in the illustrated preferred embodiment, is a plastics part is reinforced by a metal sheet 15 which partly encompasses it.

The coupling bolt 1 which is also shown in FIG. 3 has on its front part in the insertion direction a cylindrical portion 21, in the front end of which, in the insertion direction, an outer peripheral locking groove 22 has been made. The rear wall of the locking groove runs substantially vertically to the longitudinal axis of the coupling bolt 1. The wall of the locking groove then describes a pitch circle portion in the insertion direction. The radius of the pitch circle portion is approximately the same as the outer radius of the locking portion in the centre part of the locking shaft 4. A tapped hole 23 has been made in the rear end face, in the insertion direction, of the coupling bolt 1. The coupling bolt 1 can thus be screwed, for example onto the thread of one end of a rear wheel axle of a bicycle or onto a threaded bolt mounted on a bicycle frame. To enable it to be threaded on, the coupling bolt 1 has a hexagon head 24 on the tapped hole-side end. The front edge, in the insertion direction, of the hexagon head 24 serves as a boundary of the insertion path of the coupling bolt into the sleeve in the coupling housing 2. The coupling bolt 1 thereby serves as an insert piece and is the first of the two coupling parts according to the invention to be joined together within the meaning of the claimed invention.

FIG. 4a to c are different perspective views and FIG. 4d is a cross-sectional view of the locking shaft 4 which is based on a cylindrical basic body. In a middle locking segment, in the direction of the longitudinal axis of the shaft, the locking shaft has in the peripheral direction a locking portion 31 which has a lateral surface which is partly circular in cross section, and has a recess as the unlocking portion 32. The unlocking portion 32 is formed in that material is removed over almost the entire width of the shaft. The ground contour of the unlocking portion 32 has two substantially planar surfaces 33, 34, one surface 33 of which extends in the cross-sectional view of FIG. 4d from the outside of the cylindrical basic body to approximately above the rotational axis of the shaft and the other surface 34 extends lower and on the left slightly radially to the rotational axis. The surfaces 33, 34 of the ground contour are interconnected by an arc-shaped lateral surface. In this respect, surface 34 serves as a contact surface for the front end of the coupling bolt 1 when the coupling bolt is introduced into the coupling housing 2, so that the locking shaft 4 is rotated about its axis due to the insertion of the coupling bolt 1. The recess is such that the cylindrical portion 21 of the coupling bolt 1 can be moved past the core of the locking shaft 4.

Adjoining both sides of the middle locking segment is a respective unlocking segment which has next to the locking portion 31 of the locking segment a recess 35, 36 with a smaller outer radius compared to that of the cylindrical basic body. One edge of the recess is formed as a radially extending stop surface 37, 38 which slightly projects beyond the outer casing of the cylindrical basic body. The stop surfaces 37, 38 act in the same peripheral direction as the portion, forming the contact surface 34, of the unlocking portion 32. They are intended to cooperate with pins 52, 53 which are configured on the pushbutton 11, to release the locking shaft 4 from a locking position. In this respect, the recesses 35, 36 are such that the pins 52, 53 can be moved freely past the core of the locking shaft on their path to unlock the locking shaft.

Configured on one of the end faces of the locking shaft 4 is an annular piece 39 which is slotted on one side and serves as a seat for the torsion spring 6. The opposite end 41 of the shaft has a smaller diameter than the cylindrical basic body and is configured with a catch piece 42 which projects as far as the outer lateral surface of the cylindrical basic body. One side of the catch piece forms a radial stop surface 43 which acts in the same peripheral direction as the stop surfaces 37, 38. The stop surface 43 cooperates with a corresponding stop configured in the coupling housing 2 and serves to hold the locking shaft 4 in a starting position against the force of the pretensioned torsion spring 6 when the coupling bolt 1 has not been introduced into the sleeve.

Finally, the locking shaft 4 has a continuous central hole 44 in which the spindle 5 is received by which the locking shaft 4 is mounted in the coupling housing 2.

The pushbutton 11, also shown in FIG. 5, is mounted in the cover 8 and can be actuated inside the cover against the force of the spring 12. Provided on one side of the pushbutton 11 is a concave plate piece 51, on the sides of which are configured two downwardly projecting pins 52, 53 in the actuation direction of the pushbutton. The length and distance of the pins 52, 53 relative to one another is such that they can cooperate with the stop surfaces 37, 38 of the locking shaft 4 when the coupling bolt 1 has been introduced into the coupling housing 2. The lower ends of the pins are bevelled. The stop surfaces 37, 38 of the locking shaft rest in a planar manner thereon when the locking shaft is in its starting position. Pin 53 has a lug 54, the underside of which serves to lock the pushbutton against unintentional opening by a lock.

The lock cylinder 14 which is also mounted in the cover 8 is positioned in the cavity in the plate 51. The lock cylinder, which is also shown in FIG. 6, has on its underside a laterally projecting locking bolt 61 which, upon actuation of the lock, can be rotated under the lug 54 on pin 53 so that the pushbutton is stopped from being depressed.

The coupling housing 2 and the parts of the coupling mounted therein form the second coupling part within the meaning of the claimed invention.

If the two coupling parts are separated from one another, the locking shaft 4 which is pretensioned by the torsion spring 6 is held by the stop surface 43 in a starting position in the coupling housing 2, in which position contact surface 33 is located within the insertion path of the coupling bolt 1 in the sleeve and opposes the coupling bolt 1. At the same time, the stop surfaces 37, 38 rest against the pins 52, 53. When the second coupling part is positioned on the coupling bolt 1, the coupling bolt 1 presses contact surface 34 to the side so that the locking shaft 4 is rotated against the spring force of the torsion spring 6 and the unlocking portion 31 of the locking shaft 4 clears the way for the coupling bolt 1.

The coupling housing 2 can be placed so far on the coupling bolt 1 until contact surface 43, together with the locking portion 31 which adjoins thereto can swivel into the peripheral locking groove 22 formed in the coupling bolt 1, driven by the torsion spring 6. In this position, the coupling bolt 1 is locked in the sleeve. It cannot be inserted any further into the coupling housing 2 because the hexagon head 24 of the coupling bolt rests on the coupling housing 2 or on the sleeve and prevents further insertion. As an alternative or in addition to a stop for the hexagon head on the coupling housing or sleeve, a stop can also be provided for the front end of the coupling bolt in the coupling housing to delimit the insertion path of the coupling bolt in the coupling housing. In this position, the coupling bolt cannot be removed again from the coupling housing, because a rotation of the locking shaft 4, required for this purpose, is prevented by optionally the stop surface 43 and the associated stop in the coupling housing and/or the pins 52, 53 which cooperate with the stop surfaces 37, 38 of the locking shaft. The coupling bolt 1 can be released again from the coupling housing when the pushbutton 11 is actuated. As a result, the locking shaft is rotated to such an extent that the unlocking portion 32 releases the coupling bolt 1 again and it can be removed.

The actuating forces for closing and releasing the coupling essentially depend on the spring constant and on the pretension of the torsion spring and also on the distance of the part of contact surface 34, engaged with the coupling bolt 1, from the rotational axis of the locking shaft 4 or the distance of the contact surfaces of the pins 52, 53 on the stop surfaces 37, 38 from the rotational axis of the locking shaft 4. Where there are relatively great distances, the forces to be applied become smaller. If the depth of the locking groove in the coupling bolt remains the same, the pitch circle portion of the locking shaft which engages in the locking groove becomes smaller, so that an increase in the diameter of the locking shaft and thereby an increase in the distances of the effective surfaces from the axis of the locking shaft, which leads to a reduction in the actuating forces, does not necessarily involve a lengthening of the actuation paths. In any case, the forces to be applied are relatively low.

FIG. 7 shows some parts of the trailer coupling to illustrate the first two degrees of freedom of the coupling. A first degree of freedom G1 is in the joint 1 which is formed by the coupling bolt 1 and the locking shaft 4. It allows a rotation of coupling parts about the longitudinal axis of the coupling bolt. A second degree of freedom G2 arises in that attached to the free end of the spindle 72 is a sleeve piece 73 which is mounted such that it can rotate about the spindle 72. Finally, the drawbar is connected by a joint G3 (see FIG. 1) which forms a further degree of freedom.

In the following, a further embodiment of the invention in the form of a coupling for connecting a buggy wheel to the frame of a bicycle trailer will be described.

FIG. 8 shows the front frame part 81 of a bicycle trailer. In the centre thereof is a coupling 82 according to the invention for connecting a suspension 83 for a buggy wheel to the frame part 81.

Individual parts of the second coupling part 82 are shown in FIG. 9. It has a sleeve mount 84 with an upper portion 85 and a lower portion 86 which firmly sits with its upper portion 85 in a hole 87 in the front frame part 81. For this purpose, the upper portion 85 can sit in the hole 87 for example with a press fit, or it can be adhesively bonded therein or welded with the front frame part 81. In the present example, the sleeve mount 84 is secured in the frame part by a screw connection. The upper end of the sleeve mount 84 is closed by a cap 88. A plate 89 which is adapted to the profile of the frame part sits between the lower portion 86 of the sleeve mount 84 and the underside of the front frame part 81.

Positioned around the lower portion 86 of the sleeve mount 84 is a housing with a rear housing part 90 and a front housing part 91 which are interconnected by screws 92. The sleeve mount 84 is connected to the rear housing part 90 by a screw 93. Positioned in the front housing part 91 is a pushbutton 94 which can be actuated against the force of compression springs 95 located in the housing.

Positioned in the lower portion of the sleeve mount 84 is a locking shaft 96 which is held laterally in position by the rear housing part 90. A torsion spring 97 for pretensioning the locking shaft 96 is provided on one side of the locking shaft. Furthermore, a sleeve 98 is positioned in the sleeve mount 84.

The first coupling part, namely a coupling bolt 101 which can be connected to the suspension 83 for a buggy wheel is shown in FIG. 10. It has an upper cylindrical portion 102 with a peripheral locking groove 103 which has a partly circular cross section, and a lower cylindrical portion 104 with a transversely extending through hole 105 for attaching the suspension 83. Provided between the portions is a peripheral collar 106 which serves as a boundary of the insertion path into the second coupling part.

FIGS. 11 and 12 show the sleeve mount 84 and the sleeve 98. The upper portion 85 of the sleeve mount 84, like the lower portion 86 is hollow cylindrical, the internal and external diameters of the lower portion 86 being greater in each case than those of the upper portion. Provided in the lower portion, offset with respect to the longitudinal axis of the sleeve mount 84 is a continuous hole 111 which passes through the wall of the lower portion twice, is to receive and mount the locking shaft 96 and extends in a plane vertically to the longitudinal axis of the sleeve mount 84. Furthermore, the lower portion 86 of the sleeve mount 84 has on opposite sides two transversely running grooves which cooperate with clamp elements in the rear housing part 90, so that the housing is held and accurately positioned on the sleeve mount 84. In addition, a tapped hole 113 for a screw connection of the sleeve mount 84 to the rear housing part 90 is provided in the lower portion 86. The upper portion 85 has a radially running through hole 114 which is located in the same radially extending plane as the tapped hole 113 and is used to fasten the sleeve mount 84 in the front frame part 81.

The sleeve 98 has a cylindrical hollow body 121 with an externally encircling collar 122 which is formed on the underside thereof. Provided in the lower region of the hollow body 121 is a lateral recess 123 which corresponds to the hole 111 in the sleeve mount 84 and allows the locking shaft 96 to engage inside the sleeve 98. The internal diameter of the sleeve 98 corresponds to the external diameter of the upper portion 102 of the coupling bolt 101. The external diameter of the cylindrical hollow body 121 corresponds to the internal diameter of the sleeve mount 84. Provided in the upper part of the cylindrical hollow body 121 is a radially running tapped hole which, when the sleeve 98 has been introduced into the sleeve mount, aligns with the hole 114 and serves to screw both parts to the front frame part 81.

The locking shaft 96 shown in FIGS. 13a to 13c has in a middle locking segment in the peripheral direction a locking portion 131 which has a partly circular lateral surface in cross section, and has a recess which serves as an unlocking portion 132. The unlocking portion 132 is formed in that material is removed over almost the entire width of the shaft, thereby forming two planar surfaces 133, 134 which are positioned at an obtuse angle to one another. Surface 134 serves as a contact surface for the front end of the coupling bolt 101.

Located at the side of the central part of the locking shaft 96 is a respective fully round portion 135 by which the locking shaft sits in the hole 111 in the sleeve mount 84. Adjoining the fully round portions 135 on the outside are stop portions with stop surfaces 136 which are located in a plane which is parallel to a plane extending through the rotational axis of the shaft and which is at an acute angle to the surface 133. A mount 137 for a torsion spring is configured at one end face of the locking shaft 96.

The pushbutton shown in FIG. 14 has laterally next to the actuator button 141, two plate elements 142, 143 which are together arranged in a semicircle in order to laterally engage around the sleeve mount 84 in the housing. Provided at the free ends of the plate elements 142, 143 are a respective stop pin 144, 145 and also thereabove and therebelow a respective web 146, 147, 148, 149 for fixing a compression spring.

If the two coupling parts are separated from one another, the locking shaft 96, pretensioned by the torsion spring 97, is held in a starting position in the housing by the stop pins 144, 145 which stand on the stop surfaces 136 at the edge of the locking shaft 96. The locking shaft 96 is positioned so that its contact surface 134 is located inside the insertion path of the coupling bolt 101 in the sleeve 89 and opposes the coupling bolt 1. If the coupling bolt 101 is introduced into the housing, the coupling bolt 101 pushes the contact surface 134 to the side so that the locking shaft 96 is rotated against the spring force of the torsion spring 97 and the unlocking portion 132 of the locking shaft 96 clears the way in the sleeve 89 for the coupling bolt 101. The coupling bolt 101 can be inserted into the sleeve 89 until the contact surface 134, together with the locking portion 131 adjoining thereto can swivel into the peripheral locking groove 103, formed in the coupling bolt 101, driven by the torsion spring 97, the locking shaft 96 jumping back into its starting position again. In this position, the coupling bolt 101 is locked in the sleeve 89. It cannot be inserted any further into the sleeve 89 because the collar 106 of the coupling bolt 101 cannot be inserted into the sleeve 89, and neither can it be removed again from the coupling housing because a rotation of the locking shaft 96, required for this purpose, is prevented by the cooperation of the stop surfaces 136 of the locking shaft 96 and the stop pins 144, 145 of the pushbutton 114. The coupling bolt 101 can be released again from the sleeve 89 when the pushbutton 114 is actuated. As a result, the locking shaft 96 is rotated to such an extent against the force of the torsion spring 97 that the unlocking portion 132 releases the coupling bolt 101 again and it can be removed.

In this embodiment, the coupling only has one degree of freedom. The coupling bolt 101 can thus rotate freely inside the sleeve 89.

In the following, different constructive possibilities of the arrangement of the pushbutton and of the lock or lock cylinder will be shown relative to the coupling bolt and to the locking shaft engaging therein.

FIGS. 15a and b show that the pushbutton 151 is arranged in the coupling housing 152 aligning with the coupling bolt 152 so that the stop pins 154, 155 thereof are moved parallel to the longitudinal axis of the coupling bolt 152. The lock cylinder 156 is arranged in the coupling housing 152 next to the pushbutton 151. The illustrated arrangement of pushbutton and lock cylinder substantially corresponds to the arrangement of the embodiment shown in FIGS. 1 to 8, with the single difference that the locking shaft 157, unlike in the embodiment of FIGS. 1 to 8, is not arranged on the side of the lock cylinder, but on the side of the coupling bolt opposite the lock cylinder, relative to the coupling bolt, and the stop pins 154, 155 are therefore arranged differently on the pushbutton 151.

The principle arrangement of FIGS. 16a and b differs in particular from that of FIGS. 15a and b in that the pushbutton 161 and the lock cylinder 162 are arranged in the coupling housing 163 such that they align with the coupling bolt 164 to be introduced therein, the lock cylinder 162 being mounted in the pushbutton 161 and being surrounded annularly thereby. In this embodiment, it is expedient if the locking bolt 61, arranged below on the lock cylinder, cooperates with a shoulder piece formed in the coupling housing for blocking the pushbutton 161.

The arrangement shown in FIG. 17a to c basically differs in two aspects from the two previously described arrangements. Firstly, the pushbutton 171 is arranged transversely to the longitudinal axis of the coupling bolt 172. Secondly, the lock cylinder 173 is located between the pushbutton 171 and the coupling bolt 172, likewise transversely to the actuation direction of the pushbutton 171. The arrangement of the pushbutton 171 transversely to the longitudinal axis of the coupling bolt 172 requires, if at all, hardly any changes in the shape of the locking shaft 174. Subject to the selected length of the pins 175, 176 of the pushbutton 171, all that may be required is for the position of the stop surfaces of the locking shaft to be adjusted for the pins of the pushbutton relative to the position of the unlocking portion of the locking shaft.

To block the pushbutton 171, provided laterally on the underside of the lock cylinder 172 is a downwardly projecting blocking element 177 which can be oriented by the lock cylinder 172 lengthwise or transversely to the direction of movement of the pushbutton 171. If the blocking element 177 is positioned transversely to the direction of movement of the pushbutton, it rests on a lug 178, arranged on the underside of the pushbutton and thereby blocks the pushbutton.

A large number of variations of these arrangements is possible. Thus, in principle it is possible to dispense with a lock cylinder, if anti-theft protection is not required. If a lock cylinder is used, it can be arranged transversely to the pushbutton in any variant, either between pushbutton and coupling bolt (insert piece) or also substantially to the side of the pushbutton.

Furthermore, the variation possibilities in the construction of a coupling according to the invention are not restricted to the embodiments which are shown in the figures and described. As mentioned at the outset, the insert pieces of the coupling do not have to have a circular cross section, and they can also be angular or non-circular, more specifically if a degree of freedom is not required in the coupling. It is also possible to provide the sleeve, and not the insert piece, with a locking groove, and to provide the insert piece with a locking shaft together with means for rotating the locking portion of the locking shaft into the locking position, for holding the locking portion in the locking position and for releasing the locking portion from the locking position.

1. Coupling for connecting and/or holding together two parts, in particular for a bicycle trailer, having a first and a second coupling part which cooperate and can be released from each other, one of which is an insert piece which is connected to one of the parts and the other is a sleeve which is connected to the other part, the sleeve being capable of at least partly engaging around the insert piece, and the first coupling part having at least one locking groove, characterised in that mounted on or in the second coupling part is at least one locking shaft which has at least one locking segment having in the peripheral direction at least one locking portion and one unlocking portion, the locking portion having a greater radial extent than the unlocking portion, the locking shaft being arranged so that the locking portion can engage in the locking groove when the insert piece has been introduced into the sleeve, and the unlocking portion cannot engage in the locking groove, means being provided for rotating the locking portion into the locking position, for holding the locking portion in the locking position and for releasing the locking portion from the locking position.

2. Coupling according to claim 1, characterised in that the locking shaft has a rotational axis which is arranged substantially transversely to an insertion direction of the insert piece into the sleeve, preferably parallel to the locking groove.

3. Coupling according to claim 2, characterised in that the rotational axis runs through a portion of the locking groove, the unlocking portion having a negative radial extent with respect to the rotational axis.

4. Coupling according to claim 1, characterised in that a spring which acts on the locking shaft, in particular a torsion spring is provided as a means for rotating the locking shaft into the locking position.

5. Coupling according to claim 1, characterised in that provided on the locking shaft as the holding means is a stop element which cooperates with a stop element on the second coupling part.

6. Coupling according to claim 4 and claim 5, characterised in that the spring is pretensioned such that the locking shaft is held in the locking position against the spring force by the stop elements.

7. Coupling according to claim 1, characterised in that the locking shaft has at least one unlocking segment which has a stop surface which is provided on the outside of the locking shaft and cooperates with a release mechanism for releasing the locking shaft from the locking position.

8. Coupling according to claim 7, characterised in that the stop surface of the unlocking segment is located in a plane which intersects the rotational axis of the locking shaft.

9. Coupling according to claim 7, characterised in that the unlocking portion has a recess with a smaller radial extent compared to the outer radius of the locking portion in a region located upstream of the stop surface in the actuation direction of the release mechanism.

10. Coupling according to claim 1, characterised in that a manual actuator is provided as a means for releasing the locking shaft from the locking position.

11. Coupling according to claim 10, characterised in that the manual actuator is a particularly spring-mounted pushbutton.

12. Coupling according to claim 10 relating back to claim 4 or 5, characterised in that the stop element configured on the second coupling part is configured on the manual actuator and, in a starting position of the manual actuator, is in a position holding the locking portion in a locking position, the locking shaft being releasable from the locking position by actuating the manual actuator against the spring force.

13. Coupling according to claim 1, characterised by a lock which is configured to be able to prevent an unauthorised release of the locking portion from the locking position.

14. Coupling according to claim 13 relating back to either claim 11 or claim 12, characterised in that the lock is configured to be able to block an actuation of the manual actuator.

15. Coupling according to claim 1, characterised in that the insert piece is a coupling bolt having a substantially circular lateral surface in cross section and having at least one at least partly peripheral locking groove.

16. Coupling according to claim 1 in the form of a trailer coupling for a bicycle trailer.

17. Coupling according to claim 1, characterised in that one of the two coupling parts is a coupling bolt connected to a buggy wheel mount and the other coupling part is a sleeve connected to a front frame part of a bicycle trailer.

18. Coupling according to claim 1, characterised in that one of the two coupling parts is the end of a drawbar and the other coupling part is a drawbar mount configured on a bicycle trailer.

19. Coupling according to claim 17, characterised in that the bicycle trailer-side end of the drawbar is configured as the first coupling element with a locking groove and the drawbar mount is configured as the second coupling element.

20. Coupling according to claim 10, characterised in that the actuation direction of the manual actuator extends in the direction of the longitudinal axis of the insert piece.

21. Coupling according to claim 10, characterised in the actuation direction of the manual actuator extends transversely to the longitudinal axis of the insert piece.

22. Coupling according to claim 19 or 20 insofar as they relate back to claim 11, characterised in that the lock has a lock cylinder which is arranged parallel to the actuation direction of the pushbutton.

23. Coupling according to claims 11 and 14, characterised in that the lock has a lock cylinder which is mounted in the pushbutton.

24. Coupling according to claims 11 and 14, characterised in that the lock has a lock cylinder which is mounted transversely to the actuation direction of the pushbutton.
